(19) United States
(12) Patent Application Publication
(10) Pub. No.: US 2002/0094104 A1
(43) Pub. Date: Jul. 18, 2002

(54) Loudspeaker cooling device

(76) Inventor: Michael Eugene Bush, Meridian, MS (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/759,346

(22) Filed: Jan. 16, 2001

(51) Int. Cl. H04R 1/00; H04R 11/02

(52) U.S. Cl. 381/397; 381/396; 381/412

(57) ABSTRACT

A permanent magnet, coil moving loudspeaker having a front suspension, a dust cap, a cone, a rear suspension or spider, a frame, and a voice coil assembly. The voice coil assembly is comprised of a tubular former with insulation coated, electrically conductive wire, an air filter, a vent plate, a ring with radial channels and parallel walls, a front plate, a magnet, and a back plate. The spider is designed to function as a pump diaphragm that forces air to move through the vent plate and be expelled from the speaker, thus reducing the amount of heat within the loudspeaker allowing it to function more efficiently.

### BACKGROUND OF THE INVENTION

This invention relates generally to a self-cooling loudspeaker and more particular to a loudspeaker having a vent plate and a spider that function as a pump diaphragm to move air within the loudspeaker facilitating cooling thereof.

Loudspeakers are generally less than 5% efficient, and nearly all the wasted energy is converted to heat in the voice coil. Heat dissipation is a very significant problem for high performance loudspeakers.

Excessive heat within a loudspeaker can destroy the voice coil, and power compression can cause significant reductions in the sustained output. As the voice coil temperature increases, the resistance of the wire also increases. Such increased resistance results in less efficient loudspeakers that can have losses as high as 6 dB, the equivalent to reducing power input to the speaker by 75%. As a result of temperature increase, average sound pressure levels drop over time and the desired sustained acoustical output of the loudspeaker cannot be achieved.

The voice coil in a conventional loudspeaker is surrounded by materials that have poor heat conductivity characteristics, as well as an insulating layer of air. Such configuration causes a rapid build up of heat that is not readily removed. The heat remains in the massive components of the loudspeaker's motor structure for long periods of time, reducing performance capabilities.

Loudspeakers using overhung voice coils, coils which are longer than the magnetic gap of the motor structure, are the most common design. However, such loudspeakers have an inherent power handling problem. The outer portion of the voice coil that extends above the front plate is unshaded by the front plate on one side or the pole piece on the other side. This layout results in poor heat dissipation. Also, this portion of the voice coil tends to operate at higher temperatures and is usually the point of failure for loudspeakers operated at high power levels.

Most loudspeakers, with venting between the spider and frame, use cast frames due to the integration of the vents and the possible loss of strength created by the vent holes.

The vent plate allows conventional cast metal frames to be used, as well as stamped metal or molded plastic frame designs. Such diversity provides for potential cost savings with the stamped frames, and an improvement in reliability for plastic frames which may melt or deform at high temperatures.

In most loudspeakers, the spider is designed as a porous membrane so that air won't be trapped between it and the front plate. Trapping air can limit cone movement and greatly inhibit the performance of the loudspeaker at low frequencies. Occasionally, simple vents are used along with a porous spider, but this arrangement provides no significant cooling and is only intended to reduce air pressure under the spider. The motion of air with such a porous spider is normally very diffuse, with limited circulation of air around the voice coil. However, with changes in design in these areas, as illustrated in the present invention, excellent voice coil cooling can be achieved.

### SUMMARY OF THE INVENTION

It is an object of the present invention to provide a loudspeaker that is capable of venting heat from within the loudspeaker thereby cooling itself and increasing its efficiency.

The object of this invention is achieved by a loudspeaker having a front suspension; a dust cap; a cone; a spider; a frame; and a voice coil assembly. More precisely, the voice coil assembly has a tubular former with insulation coated, electrically conductive wire wound to form a coil; an air filter; a vent plate; a ring with radial channels and parallel walls, a front plate, a magnet, and a back plate/pole piece; wherein the spider is designed to function as a pump diaphragm that forces air to move through the vent plate and be expelled from the speaker, thus reducing the amount of heat within the loudspeaker and allowing it to function more efficiently.

Other objects, advantages and novel features of the invention will become more apparent from the following detailed description of the invention when taken in conjunction with the accompanying drawings.

### BRIEF DESCRIPTION OF THE DRAWINGS

FIG. 1 is a cross-sectional view of a loudspeaker of the present invention; and

FIG. 2 is an exploded perspective view of the loudspeaker of the present invention.

### DETAILED DESCRIPTION OF THE INVENTION

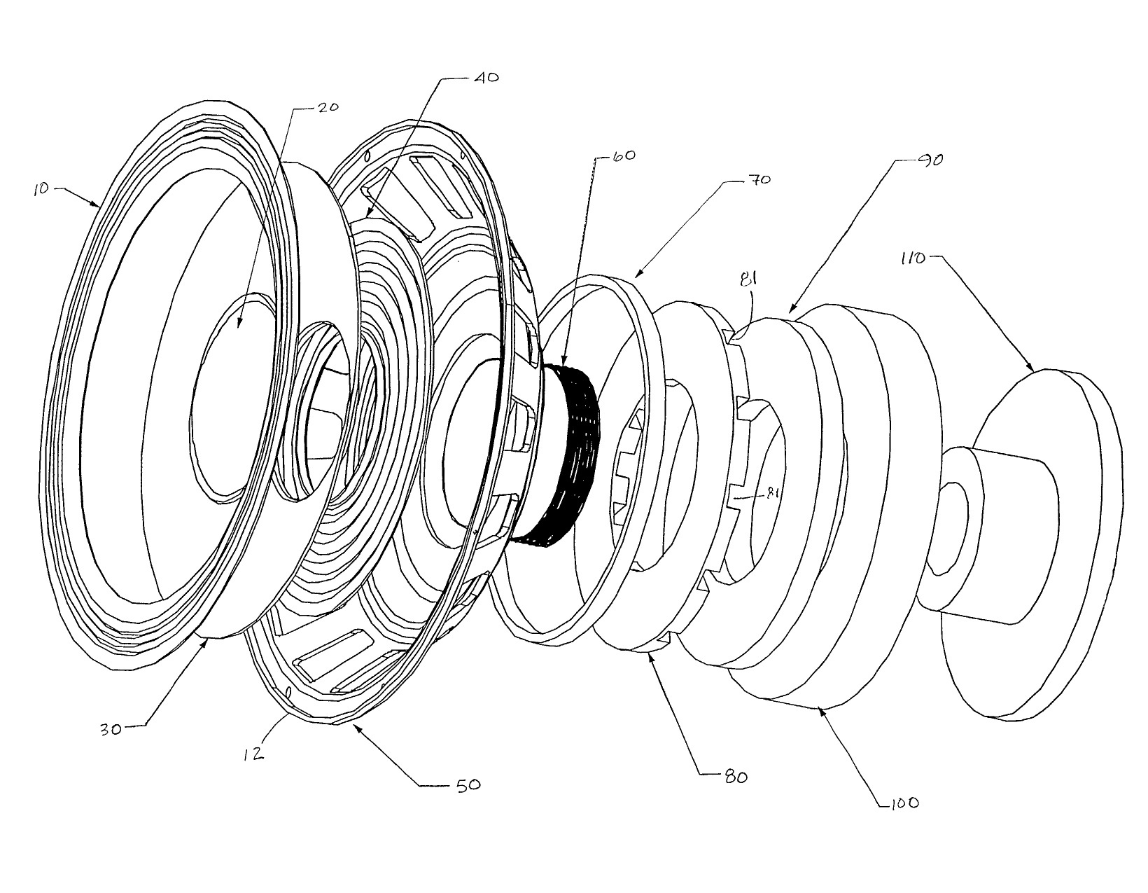

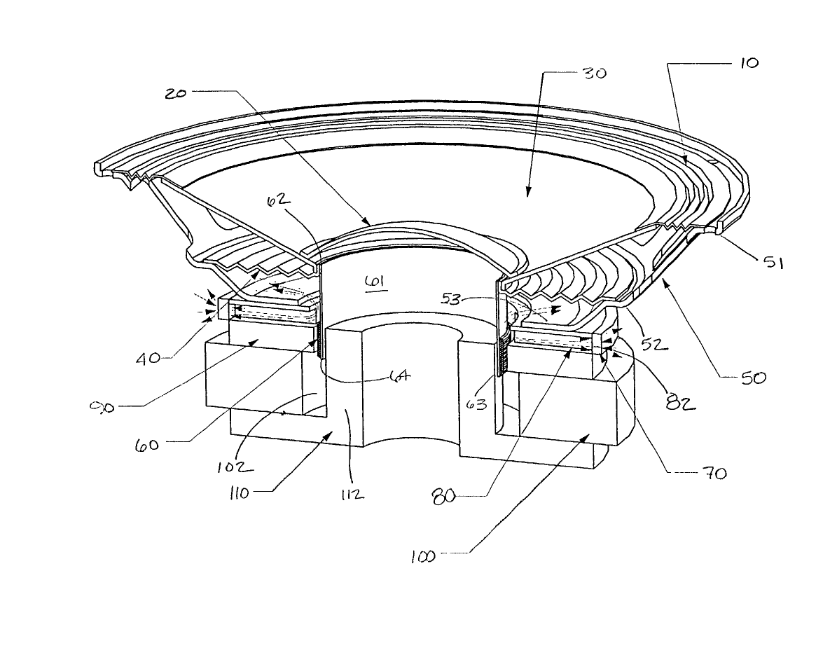

As shown in FIGS. 1 and 2, a loudspeaker cooling device 1 is a speaker with a front suspension 10 attached to the outer perimeter 51 of frame 50. The front suspension 10 is also known as a surround and is usually made of a flexible, elastic material.

A spider 40 is attached on one side to an intermediate portion 52 of the frame, and attached to the distal end 62 of a voice coil bobbin or former 61 portion of a voice coil assembly 60. The spider 40 is sealed with a coating that prevents air from flowing through it. Such a coating forces the air through a vent plate 80 that is designed to vent the air directly outside the loudspeaker and deliver high air flow directly to the voice coil 63. The spider 40 is therefor used as a pump diaphragm to move air.

A cone 30 is connected at an outer end 31 to the front suspension 10, and at an inner end 32 to the spider 40, at the location where the spider 40 is attached to the former 61 of the voice coil assembly 60.

A dust cap 20 is located at the center of the cone 30 and covers the chamber defined by the former 61 of the voice coil assembly 60. The dust cap 20 is typically made of paper, felt or plastic.

The proximal end 64 of the voice coil assembly 60 is located within the loudspeaker cooling device 1 and surrounds a pole piece 112 of a back plate 110. The voice coil assembly 60 is capable of moving along the length of the pole piece 112 when the loudspeaker is in use.

The inner perimeter 53 of the frame 30, is connected to a vent plate 80. The inside diameter of the vent plate 80 is chosen to maintain a constant cross-section in comparison with the area of the vents 81 in the vent plate 80. This configuration maximizes air flow around the voice coil 63.

An air filter 70 is positioned adjacent the outside edge 82 of the vent plate 80 and is used to filter air as it is drawn into the loudspeaker through the vents 81 that are placed in radial configuration about the vent plate 80.

The vent plate 80 is located between the inner perimeter 53 of the frame and a front plate 90, to which it is attached on the side opposite that of the inner perimeter 53.

The front plate 90 surrounds the pole piece 112 of the back plate 110 with a central air space 102 formed therebetween. One side of the front plate 90 is connected to the magnet 100 and along with the back plate 110, creates a magnetic circuit which influences the movement of the voice coil 63.

In this preferred embodiment, cool ambient air is drawn into the loudspeaker 1 as the cone 30 moves away from the magnet 100 in the positive direction. At the same time, the voice coil assembly 60 travels directly through this cool air stream and thereby cooling itself.

When the cone 30 moves toward the magnet 100 in the negative direction, air previously heated by the voice coil assembly 60 is expelled through the vents 81 to the exterior atmosphere.

The presence of a cooling air flow, as herein described, is particularly advantageous to loudspeakers with overhung voice coils 63 because the coils 63 are directly in the path of the air flowing in the vents 81 and such coils 63 thereby benefit from the cooling effect. The front overhung portion of the voice coil assembly 60, which is usually the hottest portion of the voice coil assembly 60, will typically become the coolest portion of the voice coil assembly 60 in a correct implementation of the present invention.

In order to properly exchange the air, the net volume of the radial vents 81 must total less than the possible displaced volume of the spider 40. For optimal performance, the various elements would be arranged so that the vent volume is less than half the volume of the possible spider displacement. Such an arrangement ensures that air will be exchanged at lower driver cone excursions, and it also allows for flow losses.

Basic geometry is sufficient for estimating the displacement of the various components, using the formulae for truncated cones, rectangular boxes and cylinders to solve for the displacement of various components.

Although a particular embodiment of the invention has been described in detail herein with reference to the accompanying drawings, it is to be understood that the invention is not limited to this precise embodiment, and that various changes and modifications may be effected therein by one skilled in the art without departing from the scope or spirit of the invention as defined in the appended claims.

For example, possible variations on the present loudspeaker cooling device would include an air filter to prevent entrance of foreign material into the loudspeaker, and fins or channels in the vents of the vent plate to increase surface area and improve cooling performance.

What is claimed is:

1. A loudspeaker comprising:
a front suspension attached to a frame;
a dust cap located within the middle of said front suspension;
a cone attached between said front suspension and said dust cap;
a spider attached at one end to said cone and attached at the opposite end to an intermediate portion of said frame; and
a voice coil assembly having
A back plate surrounding a pole piece;
a former located adjacent said pole piece and slidably movable along said pole piece within a magnetic gap,
a magnet surrounding said pole piece and the bottom of said magnet being located adjacent said back plate,
a front plate located adjacent the top of said magnet,
a vent plate positioned between a lower, inner perimeter of said frame and said front plate, said vent plate having a plurality of radial channels and parallel walls, and
an air filter attached to an outer perimeter of said vent plate,
wherein the spider is designed to function as a pump diaphragm that forces air to move through the magnetic gap, cooling said voice coil and then exiting the loudspeaker through said radial vents of said vent plate, thus reducing the amount of heat within the loudspeaker allowing it to function more efficiently.

2. The loudspeaker of claim 1, wherein:
said former is comprised of insulation coated, electrically conductive wire wound to form a coil.

3. The loudspeaker of claim 2, wherein:
said surround is made of flexible, elastic material.

4. The loudspeaker of claim 1, wherein:
Said dust cap 20 is comprised of one of
a) paper,
b) felt, or
c) plastic.

5. The loudspeaker of claim 1, wherein:
said radial vents are perpendicular to said magnetic gap.

6. The loudspeaker of claim 1, wherein:
said radial vents are perpendicular to said pole piece.
